(19) United States
(12) Patent Application Publication
(10) Pub. No.: US 2021/0147302 A1
(43) Pub. Date: May 20, 2021

(54) METHOD TO ACHIEVE A SMOOTH SURFACE WITH PRECISE TOLERANCE CONTROL FOR A COMPLEX (NON-FLAT) GEOMETRY

(71) Applicant: Rolls-Royce High Temperature Composites Inc., Cypress, CA (US)

(72) Inventors: Camila S. Bortoluzzi, Huntington Beach, CA (US); Stephen J. Richards, Aliso Viejo, CA (US)

(21) Appl. No.: 17/066,814

(22) Filed: Oct. 9, 2020

Related U.S. Application Data
(60) Provisional application No. 62/935,733, filed on Nov. 15, 2019.

(51) Int. Cl. C04B 35/80; C04B 35/628; C04B 35/657

(52) U.S. Cl. CPC C04B 35/80; C04B 35/62863; C04B 35/62878; C04B 35/62894; C04B 35/657; C04B 2235/614; C04B 2235/3826; C04B 2235/5244; C04B 2235/524; C04B 2235/5252; C04B 2235/616; C04B 35/62884

(57) ABSTRACT

A method of producing a CMC having a smooth surface includes forming a fiber preform; rigidizing the preform with an interphase coating; infiltrating a ceramic slurry into the preform to form a green body; conducting secondary operations on the green body; applying a slurry-based layer onto a portion of the green body; and infiltrating the green body with a molten silicon or silicon alloy, such that the CMC exhibits a smooth surface. The application of the slurry-based surface layer onto the green body includes placing the green body into a tool fixture having upper and lower components, such that a gap is present between the green body and at least one of the upper and lower components; and delivering a surface layer slurry into at least one gap, such that the surface layer slurry forms the slurry-based layer on at least a portion of the green body.

### RELATED APPLICATION

This present patent document claims the benefit of priority under 35 U.S.C. § 119(e) to U.S. Provisional Patent Application No. 62/935,733, filed on Nov. 15, 2019, and which is hereby incorporated by reference in its entirety.

### TECHNICAL FIELD

This disclosure relates generally to a method of forming a ceramic matrix composite (CMC) component having a smooth outer surface. More specifically, this disclosure relates to a method of forming a smooth surface layer on a CMC component.

### BACKGROUND

The statements in this section merely provide background information related to the present disclosure and may not constitute prior art.

A ceramic matrix composite (CMC), which includes ceramic fibers in the shape of a fiber preform embedded in a ceramic matrix, exhibits a combination of properties that makes the ceramic matrix composite a promising candidate for use in components that are utilized in a variety of industrial applications that require excellent thermal and mechanical properties along with low weight. However, during post-infiltration processing, i.e., during subsequent machining operations, or when in use in a desired application, the CMC component is susceptible to both physical and environmental damage. For example, a CMC may react with gases or compounds (e.g., water vapor, etc.) present in a high temperature operating environment, such as that encountered with a gas turbine engine system. These reactions may damage the CMC, thereby, reducing the mechanical properties exhibited the CMC and limiting the useful life-time of the component.

A CMC component may be coated with a smooth barrier layer in order to reduce exposure of the CMC component to gases or compounds present in the operating environment. However, many such barrier layers are plagued with the formation of cracks formed during drying and handling of the coated CMC, the occurrence of which results in the formation of an undesirable microstructure (e.g., cracks filled with silicon) or in an increase in manufacturing costs due to amount of rework required or the creation of an excessive amount of scrap.

### DRAWINGS

In order that the disclosure may be well understood, there will now be described various forms thereof, given by way of example, reference being made to the accompanying drawings, in which:

FIG. 1 is a flowchart of a method of forming a CMC component having a smooth outer surface according to the teachings of the present disclosure;

FIG. 2 is a flowchart of a method for applying a slurry-based surface layer onto at least a portion of the outer surface of the green body formed in the method of FIG. 1;

FIG. 3A is a schematic representation of a tool fixture used to implement the process of FIG. 2 with the application of a surface layer slurry to both surfaces or sides of the green body; and

FIG. 3B is another schematic representation of a tool fixture used to implement the process of FIG. 2 with the application of a surface layer slurry to one surface or side of the green body.

The drawings described herein are for illustration purposes only and are not intended to limit the scope of the present disclosure in any way.

### DETAILED DESCRIPTION

The present disclosure generally provides a method of producing a ceramic matrix composite (CMC) component having a smooth outer surface layer. This layer is generally formed using a surface layer slurry having a composition that reduces cracking during manufacturing and handling. The composition of the surface layer slurry further enhances the green strength of the surface layer, such that the surface layer slurry provides the ability to achieve a smooth surface layer on a CMC component. The surface layer slurry further provides the ability to achieve a precise surface geometry and to control the smooth layer thickness and uniformity. Finally, the surface layer slurry provides the CMC component with a grit blastable smooth surface capable of being useful for sealing or as a flow path surface.

The following description is merely exemplary in nature and is in no way intended to limit the present disclosure or its application or uses. For example, the method of forming a CMC component with a smooth outer surface according to the teachings contained herein is described throughout the present disclosure in conjunction with a specific tool fixture in order to more fully illustrate the functionality of the system and the use thereof. The use of such a method with other tool fixture designs in the manufacturing of a CMC component is contemplated to be within the scope of the present disclosure.

For the purpose of this disclosure the terms “about” and “substantially” are used herein with respect to measurable values and ranges due to expected variations known to those skilled in the art (e.g., limitations and variability in measurements).

For the purpose of this disclosure, the terms “at least one” and “one or more of” an element are used interchangeably and may have the same meaning. These terms, which refer to the inclusion of a single element or a plurality of the elements, may also be represented by the suffix “(s)”at the end of the element. For example, “at least one source”, “one or more sources”, and “source(s)” may be used interchangeably and are intended to have the same meaning.

For purposes of promoting an understanding of the principles of the present disclosure, reference will now be made to the embodiments illustrated in the drawings, and specific language will be used to describe the same. It should be understood that throughout the description, corresponding reference numerals indicate like or corresponding parts and features. One skilled in the art will further understand that any properties reported herein represent properties that are routinely measured and may be obtained by multiple different methods. The methods described herein represent one such method and other methods may be utilized without exceeding the scope of the present disclosure.

No limitation of the scope of the present disclosure is intended by the illustration and description of certain embodiments herein. In addition, any alterations and/or modifications of the illustrated and/or described embodiment(s) are contemplated as being within the scope of the present disclosure. Further, any other applications of the principles of the present disclosure, as illustrated and/or described herein, as would normally occur to one skilled in the art to which the disclosure pertains, are contemplated as being within the scope thereof.

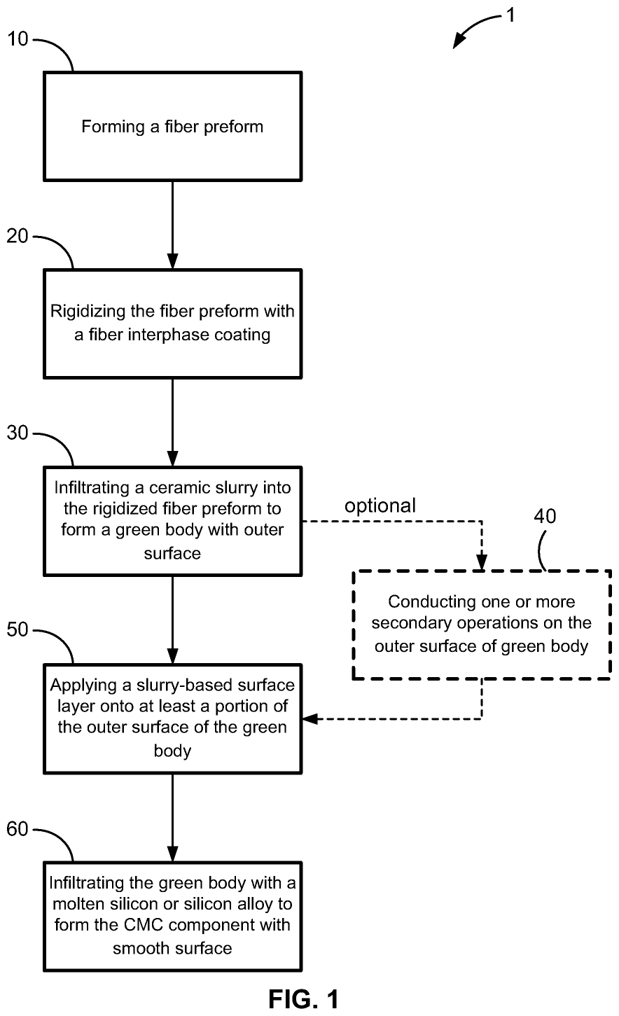

Referring to FIG. 1, a method 1 of producing a ceramic matrix composite (CMC) component is provided. This method 1 comprises the steps of: forming 10 a fiber preform; rigidizing 20 the fiber preform with a fiber interphase coating; infiltrating 30 a ceramic slurry into the rigidized fiber preform to form a green body with an outer surface; optionally, conducting 40 one or more secondary operations on the green body; applying 50 a slurry-based surface layer onto at least a portion of the outer surface of the green body; and infiltrating 60 the green body with a molten silicon or silicon alloy to form the CMC component, such that the CMC component exhibits a smooth outer surface. Alternatively, the slurry-based surface layer may be applied to substantially all of the outer surface of the green body. The surface finish of the slurry-based surface layer may correspond to an average surface roughness Rₐ of about 500 micro-in or less; alternatively about 300 micro-in or less, or about 100 micro-in or less. The slurry-based surface layer may have a thickness that is in the range of about 10 micrometers (μm) to about 1,000 micrometers (μm); alternatively in the range of about 25 micrometers (˜1 mil) to about 1,524.0 micrometers (˜60 mil); alternatively from about 25 μm to about 508 μm; alternatively, from about 25 μm to about 254 μm.

According to one aspect of the present disclosure, the slurry-based surface layer is applied to the top, bottom, and edges of the green body. According to another aspect of the present disclosure, the slurry-based surface layer is applied to the edges and only one side, i.e., either the top side or the bottom side, of the green body. The term “substantially all” may refer to the outer surface of the entire green body (e.g., top, bottom, and edges) or to the outer surface relative to edges and one side only (e.g., top or bottom) of the green body. The term “substantially all” may be quantified by meaning 80% or more of the outer surface; alternatively, 90% or more of the outer surface; alternatively, greater than 95% of the outer surface; alternatively, 99% or more of the outer surface. .

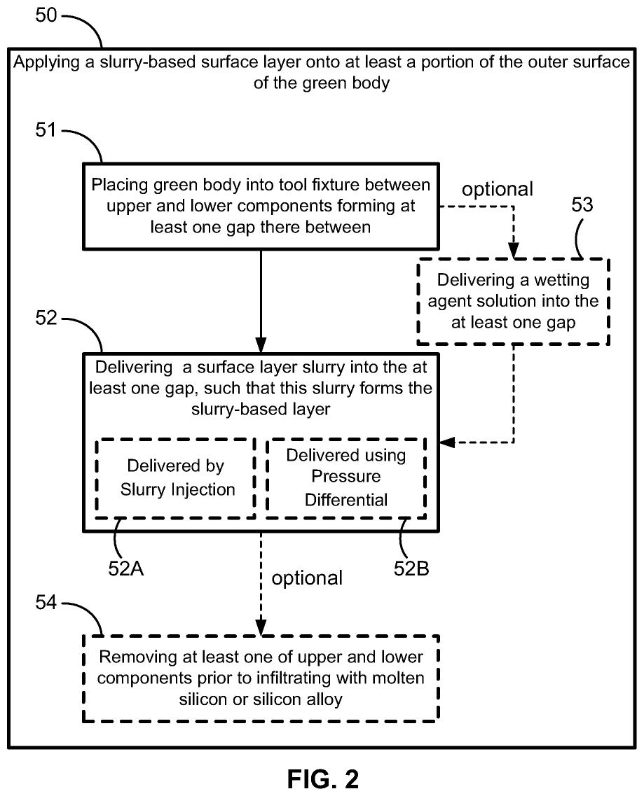

Referring now to FIG. 2, the step of applying 50 the slurry-based surface layer onto at least a portion of the outer surface of the green body may be further subdivided into multiple steps 51-54. The application of the slurry-based surface layer comprises placing 51 the green body into a tool fixture having an upper component and a lower component such that a gap is present between the green body and the at least one of the upper and lower components; and delivering 52 a surface layer slurry into the at least one gap present between the green body and the upper and/or lower components, such that the surface layer slurry forms the slurry-based layer on at least a portion of the outer surface of the green body. Alternatively, the surface layer slurry is delivered to each of the gaps that are formed by the green body and upper component and the green body and the lower component. The surface layer slurry may be delivered to the gap(s) by slurry injection 52A, i.e., under pressure, or through the use of a pressure differential 52B. A pressure differential may be created between the green body and the surface of the upper or lower components by any method known in the art, including but not limited to creating a vacuum.

When desirable, a wetting agent solution may be delivered 53 into the at least one gap present between the green body and the upper and/or lower components prior to delivering the surface layer slurry. In addition, one or more of the upper and lower components may be removed 54 or kept in place prior to infiltrating the green body with the molten silicon or silicon alloy. According to one aspect of the present disclosure, at least a portion of the surface of the upper and/or lower component that is facing the green body may be smooth, textured or include a graphical image, which may comprise a picture and/or text.

A ceramic matrix composite (CMC) component is generally made from a lay-up of a plurality of continuous ceramic fibers, formed to a desired shape. At this stage in the production of a CMC article or component, the lay-up is generally known as a ceramic fiber preform, fiber preform, or preform. Referring once again to FIG. 1, the fiber preform, which can be partially rigid or non-rigid, may be constructed 10 in any number of different configurations. For example, the preform may be made of filament windings, braiding, and/or knotting of fibers, and may include two-dimensional and three-dimensional fabrics, unidirectional fabrics, and/or nonwoven textiles. The fibers used in the preform, furthermore, may comprise any number of different materials capable of withstanding the high processing temperatures used in preparing and operating CMC components, such as, but not limited to, carbon fibers, ceramic fibers (e.g., silicon carbide, alumina, mullite, zirconia, or silicon nitride), which can be crystalline or amorphous. The ceramic fibers may be suitably coated by various methods. Alternatively, the fiber preform comprises fibers that include one or more of silicon carbide (SiC), silicon nitride (Si₃N₄), or a mixture or combination thereof. Each of the fibers is individually selected and may be of the same or different composition and/or diameter. Alternatively, the fibers are the same in at least one of said composition and/or diameter. The ceramic fiber filaments may have a diameter that is between about 1 micrometer (μm) to about 50 μm; alternatively, about 5 μm to about 30 μm; alternatively, about 10 μm to about 20 μm.

The ceramic fibers in the preform may be treated or rigidized 20 by applying a single fiber interphase coating or a plurality of such coatings thereto. The general purpose of the interphase coating(s) is to facilitate and/or enhance compatibility between the ceramic fibers and the ceramic slurry and/or the molten silicon or silicon alloy that is subsequently added in order to densify the preform and form the ceramic matrix composite (CMC). The rigidizing of the fiber preform may also enhance the toughness (e.g., crack reduction) exhibited by the final CMC component, as well as reduce or prevent reaction between the ceramic fibers and the molten metal or metal alloy.

The interphase coating(s) may be applied to the fiber preform using any method known to one skilled in the art, including but not limited to Chemical Vapor Infiltration (CVI) or Chemical Vapor Deposition (CVD) processes; alternatively, by a CVI process. Several examples of such interphase coatings include, without limitation, carbon, aluminum nitride, boron nitride, silicon nitride, silicon carbide, boron carbide, metal borides, transition metal silicides, transition metal oxides, transition metal silicates, rare earth metal silicates, and mixtures or combinations thereof. Alternatively, the fiber interphase coating comprises silicon carbide (SiC), silicon nitride (Si₃N₄), or a mixture or combination thereof. When used, the fiber interphase coating(s) may have a thickness that is in the range of about 0.01 micrometers (μm) to about 20 micrometers (μm); alternatively between about 0.05 μm to 15 μm; alternatively from about 0.1 μm to about 10 μm; alternatively, from about 0.5 μm to about 5 μm.

Still referring to FIG. 1, the fiber preform may be transformed 30 into a green body by the infiltration of a ceramic slurry into the preform and heating the ceramic slurry in the preform. As the ceramic slurry infiltrates 30 the fiber preform, the solid particulate fillers flow into the pores and interstices that exist between the ceramic fibers. The infiltration 30 of the ceramic slurry may be accomplished in a single step or may comprise multiple infiltration steps in order to ensure that the fiber preform is fully impregnated with the solid particulate fillers. Each additional infiltration step may be performed using a ceramic slurry composition that is either the same as or different form the composition used in the first impregnation step. According to one aspect of the present disclosure, the ceramic slurry comprises ceramic particulate fillers having a composition of silicon carbide (SiC), silicon nitride (Si₃N₄), or a mixture thereof.

Following slurry infiltration 30, the resulting green body may be subjected to 40 one or more secondary operations when necessary or desirable. Several examples of these secondary operations include, without limitation, the removal of excess ceramic slurry, defects, or other surface imperfections from the green body, as well as drying the green body in order to remove water or other residual solvents that may remain within the green body. The removal of the imperfections or defects may be accomplished by any means known to one skilled in the art, including but not limited to grinding, sanding, brushing, or polishing with or without the an abrasive medium. The drying of the green body may be accomplished by any suitable manner, including without limitation, drying at ambient temperature under vacuum at about 1 Torr or at ambient pressure along with exposure to a temperature that is in the range of ambient, room temperature up to 400° C.; alternatively, greater than 100° C.; alternatively, up to about 150° C. A ramp rate of less than 2° C. per minute; alternatively, about 2° C. per minute; alternatively, between 1° C./minute to 3° C./minute is used to increase the temperature from ambient temperature to a predetermined temperature.

Referring once again to FIGS. 1 and 2, a slurry-based surface layer is applied 50 onto the outer surface of the green body using a surface layer slurry after completion of the initial infiltration 30 of a ceramic slurry into the fiber preform and the optional performance 40 of any secondary operations. The composition of this surface layer slurry may be the same composition or a different composition than that used for the ceramic slurry infiltrated 30 into the fiber preform. Alternatively, the composition of the ceramic slurry used to infiltrate 30 the fiber preform is the same composition as that used for the surface layer slurry.

The surface layer slurry may comprise, consist essentially of, or consist of a plurality of solid particulate fillers, one or more reactive additives, a solvent, and optionally, one or more dispersants and/or binders. The surface layer slurry may comprise a solid loading in the range of about 5 vol. % to about 80 vol. %; alternatively in the range of about 10 vol. % to about 70 vol. %; alternatively, in the range of about 15 vol. % to about 65 vol. %; alternatively, in the range of about 20 vol. % to about 60 vol. %, relative to the overall volume of the surface layer slurry.

The solid particulate fillers in the surface layer slurry may comprise, without limitation aluminum nitride, aluminum diboride, boron carbide, alumina, mullite, zirconia, carbon, silicon carbide, silicon nitride, transition metal nitrides, transition metal borides, rare earth oxides, and mixtures and combinations thereof. Alternatively, the solid particulate fillers comprise silicon carbide (SiC), silicon nitride (Si₃N₄), or a mixture or combination thereof. The solid particulate fillers may comprise one or more regular or irregular shapes including, without limitation, spheres and rods. The size of the solid particulate fillers may vary, but generally, exhibit a diameter, i.e., the length of major dimension, that is less than about 50 micrometers; alternatively in the range of about 100 nanometers (nm) up to about 50 micrometers (μm); alternatively, greater than 200 nm; alternatively, between about 300 nm and about 25 μm.

The solid particulate fillers are typically present in various sizes and give rise to a particle size distribution that can be characterized by a mean average particle size or diameter. These solid particulate fillers may result in a mono-, bi-, or multi-modal distribution being observed upon the measurement of a particle size distribution for the surface layer slurry using any conventional technique, such as sieving, microscopy, Coulter counting, dynamic light scattering, or particle imaging analysis, to name a few.

The one or more reactive additives included in the composition of the surface layer slurry may comprise, without limitation, at least one of graphite, diamond, carbon black, molybdenum (Mo), and tungsten (W). Such reacative additives may promote reactions with the molten material (e.g., silicon or a silicon alloy) during melt infiltration that may reduce or eliminate unreacted silicon metal from being on or near the outer surface of the finished CMC component.

The solvent present in the surface layer slurry may be any solvent that is known to be used for the manufacturing of a ceramic matrix composite (CMC) component. Several examples, of such solvents include, but are not limited to, water, an organic solvent, such as polyvinylpyrrolidone, methyl ethyl ketone, aromatic hydrocarbons, and alcohols, including methanol, ethanol, isopropanol, or polyvinyl alcohol, to name a few, as well as mixtures or combinations thereof.

The one or more dispersants, optionally included in the composition of the surface layer slurry may comprise, but not be limited to, an anionic, cationic, or nonionic surfactant, including for example, polyethylene glycol (PEG), ammonium polyacrylate, polyvinyl butyral, a phosphate ester, and polyethylene imine. The binders, included in the composition of the surface layer slurry may comprise, without limitation, an acrylic emulsion polymeric binder.

Referring once again to FIG. 1, one of the final steps in the fabrication of a ceramic matrix composite (CMC) is melt infiltration, in which a molten metal or metal alloy is infiltrated 60 into any porosity that remains or is still present in the fiber preform. This molten metal or metal alloy occupies any remaining interstices that may be present between the solid particulate fillers and ceramic fibers until the green body is fully densified to less than about 7% porosity; alternatively, 5% porosity; alternatively, less than about 3% porosity; alternatively, between 0% and about 1% porosity in the finished CMC component.

As used herein the term “metal or alloy” is intended to refer to a matrix infiltrant, which may comprise any number of materials such as, but not limited to, polymers, metals, and ceramics. Several specific examples of metals that may be used to infiltrate the fiber preform may comprise, without limitation, aluminum, silicon, nickel, titanium, or mixtures and alloys thereof. Several specific examples of ceramics that may be used to infiltrate the fiber preform may include, without limitation, silicon carbide, silicon nitride, alumina, mullite, zirconia, and combinations thereof. Alternatively, the metal or metal alloy infiltrant is silicon, silicon carbide, silicon nitride, or a combination thereof (e.g., silicon/silicon carbide, etc.). When desirable, the metal or metal alloy particles may be combined with other additives or process aids.

The infiltration of the metal or metal alloy may be accomplished at a temperature of at least 1,000° C.; alternatively, about 1,200° C. to about 1,700° C.; alternatively, between about 1,350° C. and about 1,550° C. The duration of the infiltration may range between about 5 minutes to 5 hours; alternatively, from 15 minutes to 4 hours; alternatively, from about 20 minutes to about 2 hours. The infiltration of the molten silicon or silicon alloy may optionally be carried out under vacuum or in an inert environment under atmospheric pressure in order to minimize evaporative losses. Following the infiltration of the metal or metal alloy, the ceramic matrix composite may optionally be machined to form a suitable finished component or article.

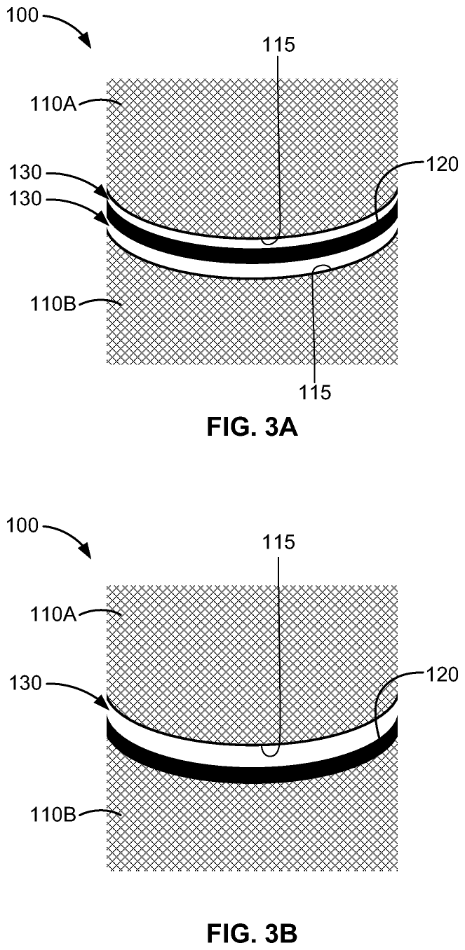

Referring now to FIGS. 3A and 3B, the tool fixture 100 may comprise an upper component 110A and a lower component 110B having a surface 115 that conforms to the shape of the fiber preform or green body 120. In this sense, the tool fixture 100 is similar to a mold with each half of the mold 110A, 110B having a surface 115 that faces the green body 120 and forms a cavity sufficiently sized to fit the green body 120 therein. At least one of the surfaces 115 of the tool fixture that faces the green body 120 comprises a portion that is smooth, textured, or contains a graphical image, wherein the graphical image comprises a picture and/or text. The tool fixture 100 may be formed of any suitable material, including, for example, graphite, slilica, alumina, a metal, or a metal alloy.

The tool fixture 100 may include a means or method (not shown) that is capable of precisely locating or positioning the green body 120 within the tool fixture 100 or mold. The means for locating the green body 120 may include but not be limited to, the inclusion of one or more pins, pillars, knock out extensions, ribs, rings, core blocks, cavities, or sprues. Upon locating the green body 120 within the tool fixture 100, a gap 130 is formed between the green body 120 and both the surface of the upper component 110A and the lower component 110B (see FIG. 3A) or between the green body 120 and the surface 115 of only one of the upper and lower components 110A, 110B (see FIG. 3B). Subsequent application of a surface layer slurry into the gap(s) 130 results in the formation of a slurry-based surface layer that may reduce the presence of any peaks or valleys associated with the outer surface of the green body 120, thereby establishing a smoother surface finish. The smoothness of slurry-based surface layer may be enhanced by formulating the surface layer slurry to have a viscosity that is less than 1,000 cP; alternatively about 500 cP or less; alternatively, less than 300 cP in order to maintain sufficient flowing or movement of the surface layer slurry during application.

### EXAMPLE 1

### Forming a Smooth Surface (FIG. 3A)

The green body 120 formed upon infiltrating the rigidized fiber preform with a ceramic slurry is placed or located within a tool fixture 100 that comprises an upper component 110A and a lower component 110B, such that a gap 130 is formed on the edges and both sides of the green body 120 and the surface 115 of the upper and lower components 110A, 110B. A surface layer slurry with a 50 vol. % solid loading and consisting of 2.5 μm nominal size silicon carbide (SiC) powder, an acrylic emulsion polymeric binder (Duramax™, Rohm and Haas Co., Philadelphia, Pa.), and water is prepared by ball milling for 4 hours and then placed into a container.

A wetting agent solution containing an ethoxylated acetylenic diol (0.1% Dynol solution, Evonik Industries, Allentown, Pa.) is injected into the gaps 130 between the green body 120 and the surfaces 115 of the upper and lower components 110A, 110B prior to the application of the surface layer slurry. The surface layer slurry is de-gassed (e.g., dissolved or trapped air is removed) for 10 minutes at 20-25 in.Hg and then injected into the gaps 130 between the green body 120 and the upper and lower components 110A, 110B of the tool fixture 100. The green body with the slurry-based surface layer applied is allowed to dry prior to being removed from the tool fixture 100. After final densification is achieved by silicon alloy melt infiltration, the resulting CMC component exhibits a smooth outer surface.

### EXAMPLE 2

### Forming a Smooth Surface (FIG. 3B)

The green body 120 formed upon infiltrating the rigidized fiber preform with a ceramic slurry is placed or located in a tool fixture 100, such that a gap 130 is formed on the edges and one side of the green body 120 and the surface 115 of the upper component 110A. Although the gap in this Example 2 and FIG. 3B is shown between the green body 120 and the upper component 110A, one shall understand that the lower component 110B could be used instead of the upper component 110A without exceeding the scope of the present disclosure. A surface layer slurry with a 50 vol. % solid loading and consisting of 2.5 μm nominal size silicon carbide (SiC) powder, an acrylic emulsion polymeric binder (Duramax™, Rohm and Haas Co., Philadelphia, Pa.), and water is prepared by ball milling for 4 hours and then placed into a container.

A wetting agent solution containing an ethoxylated acetylenic diol (0.1 Dynol solution, Evonik Industries, Allentown, Pa.) is injected into the gap 130 between the green body 120 and the surface 115 of the upper component 110A prior to the application of the surface layer slurry. The surface layer slurry is de-gassed (e.g., dissolved or trapped air is removed) for 10 minutes at 20-25 in.Hg and then injected into the gap 130 between the green body 120 and the upper component 110A of the tool fixture 100. The green body 120 with the slurry-based surface layer is allowed to dry. In this Example 2, the green body 120 with the slurry-based surface layer applied is left in the tool fixture 100 for use in subsequent operations. After final densification is achieved by silicon alloy melt infiltration, the resulting CMC component exhibits a smooth outer surface.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

The subject-matter of the disclosure may also relate, among others, to the following aspects:

A first aspect relates to a method of producing a ceramic matrix composite (CMC) component having a smooth outer surface, the method comprising steps of: forming a fiber preform; optionally, rigidizing the fiber preform with a fiber interphase coating; infiltrating a ceramic slurry into the rigidized fiber preform to form a green body having an outer surface; optionally, conducting one or more secondary operations on the outer surface of the green body; applying a slurry-based surface layer onto at least a portion of the outer surface of the green body; and infiltrating the green body with a molten silicon or silicon alloy to form the CMC component, such that the CMC component exhibits a smooth outer surface.

A second aspect relates to the method of the first aspect, wherein the slurry-based surface layer is applied to substantially all of the outer surface of the green body.

A third aspect relates to the method of the first or second aspect, wherein the slurry-based surface layer exhibits a thickness that is in the range of about 25.4 micrometers (1 mil) to about 1,524.0 micrometers (60 mil).

A fourth aspect relates to the method of any preceding aspect, wherein rigidizing the fiber preform with a fiber interphase coating uses a chemical vapor infiltration (CVI) process.

A fifth aspect relates to the method of any preceding aspect, wherein the fiber preform comprises fibers that include one or more of silicon carbide (SiC), silicon nitride (Si₃N₄), or a mixture thereof.

A sixth aspect relates to the method of any preceding aspect, wherein the fiber interphase coating comprises silicon carbide (SiC), silicon nitride (Si₃N₄), or a mixture thereof.

A seventh aspect relates to the method of any preceding aspect, wherein the ceramic slurry used to infiltrate the rigidized fiber preform to form a green body comprises silicon carbide (SiC), silicon nitride (Si₃N₄), or a mixture thereof.

An eighth aspect relates to the method of any preceding aspect, wherein the step of applying the slurry-based surface layer onto the outer surface of the green body comprises: placing the green body into a tool fixture having an upper component and a lower component such that a gap is present between the green body and the at least one of the upper and lower components; and delivering a surface layer slurry into the at least one gap present between the green body and the upper and/or lower components, such that the surface layer slurry forms the slurry-based layer on at least a portion of the outer surface of the green body.

A ninth aspect relates to the method of the eighth aspect, wherein the surface layer slurry is delivered to the gaps present between the green body and both the upper and lower components.

A tenth aspect relates to the method of the eighth or ninth aspect, wherein the surface layer slurry consists of a plurality of solid particulate fillers, one or more reactive additives, a solvent, and optionally, one or more dispersants and/or a binders.

An eleventh aspect relates to the method of any of the eighth through the tenth aspects, wherein the surface layer slurry comprises a solid loading in the range of about 10 vol. % to about 70 vol. % relative to the overall volume of the rework slurry.

A twelfth aspect relates to the method of any of the eighth through the eleventh aspects, wherein the surface layer slurry is delivered to the gap by slurry injection.

A thirteenth aspect relates to the method of any of the eighth through the twelfth aspects, wherein the surface layer slurry is delivered to the gap through the use of a pressure differential.

A fourteenth aspect relates to the method of any of the eighth through the thirteenth aspects, wherein the composition of the surface layer slurry is the same as the composition of the ceramic slurry.

A fifteenth aspect relates to the method of any of the eighth through the fourteenth aspects, wherein the method further comprises delivering a wetting agent solution into the at least one gap present between the green body and the upper and/or lower components prior to delivering the surface layer slurry.

A sixteenth aspect relates to the method of any of the eighth through the fifteenth aspects, wherein at least one of the upper and lower components has a surface facing the green body that is smooth, textured, or includes a graphical image.

A seventeenth aspect relates to the method of any of the eighth through the fourteenth aspects, wherein the method further comprises removing one or more of the upper and lower components prior to infiltrating the green body with the molten silicon or silicon alloy.

An eighteenth aspect relates to the method of the tenth aspect, wherein the solid particulate fillers in the surface layer slurry comprise silicon carbide (SiC), silicon nitride (Si₃N₄), or a mixture thereof.

A nineteenth aspect relates to the method of the tenth or eighteenth aspect, wherein the one or more reactive additives in the surface layer slurry includes at least one of graphite, diamond, carbon black, molybdenum (Mo), and tungsten (W).

A twentieth aspect relates to the method of any of the tenth, eighteenth and/or nineteenth aspects, wherein the solvent in the surface layer slurry is water, an organic solvent, or a mixture thereof.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method of producing a ceramic matrix composite (CMC) component having a smooth outer surface, the method comprising steps of:
forming a fiber preform;
infiltrating a ceramic slurry into the rigidized fiber preform to form a green body having an outer surface;
applying a slurry-based surface layer onto at least a portion of the outer surface of the green body; and
infiltrating the green body with a molten silicon or silicon alloy to form the CMC component, such that the CMC component exhibits a smooth outer surface.

2. The method according to claim 1, wherein the slurry-based surface layer is applied to substantially all of the outer surface of the green body.

3. The method according to claim 1, wherein the slurry-based surface layer exhibits a thickness that is in the range of about 25.4 micrometers (1 mil) to about 1,524.0 micrometers (60 mil).

4. The method according to claim 1, further comprising rigidizing the fiber preform with a fiber interphase coating using a chemical vapor infiltration (CVI) process.

5. The method according to claim 1, wherein the fiber preform comprises fibers that include one or more of silicon carbide (SiC), silicon nitride (Si₃N₄), or a mixture thereof.

6. The method according to claim 1, further comprising conducting one or more secondary operations on the outer surface of the green body.

7. The method according to claim 1, wherein the ceramic slurry used to infiltrate the rigidized fiber preform to form a green body comprises silicon carbide (SiC), silicon nitride (Si₃N₄), or a mixture thereof.

8. The method according to claim 1, wherein the step of applying the slurry-based surface layer onto the outer surface of the green body comprises:
placing the green body into a tool fixture having an upper component and a lower component such that a gap is present between the green body and the at least one of the upper and lower components; and
delivering a surface layer slurry into the at least one gap present between the green body and the upper and/or lower components, such that the surface layer slurry forms the slurry-based layer on at least a portion of the outer surface of the green body. The method according to claim 8, wherein the surface layer slurry is delivered to the gaps present between the green body and both the upper and lower components.

10. The method according to claim 8, wherein the surface layer slurry comprises a plurality of solid particulate fillers, one or more reactive additives, and a solvent.

11. The method according to claim 8, wherein the surface layer slurry comprises a solid loading in the range of about 10 vol. % to about 70 vol. % relative to the overall volume of the rework slurry.

12. The method according to claim 8, wherein the surface layer slurry is delivered to the gap by slurry injection.

13. The method according to claim 8, wherein the surface layer slurry is delivered to the gap through the use of a pressure differential.

14. The method according to claim 8, wherein a composition of the surface layer slurry is the same as a composition of the ceramic slurry.

15. The method according to claim 8, wherein the method further comprises delivering a wetting agent solution into the at least one gap present between the green body and the upper and/or lower components prior to delivering the surface layer slurry.

16. The method according to claim 8, wherein at least one of the upper and lower components has a surface facing the green body that is smooth, textured, or includes a graphical image.

17. The method according to claim 8, wherein the method further comprises removing one or more of the upper and lower components prior to infiltrating the green body with the molten silicon or silicon alloy.

18. The method according to claim 10, wherein the solid particulate fillers in the surface layer slurry comprise silicon carbide (SiC), silicon nitride (Si₃N₄), or a mixture thereof.

19. The method according to claim 10, wherein the one or more reactive additives in the surface layer slurry includes at least one of graphite, diamond, carbon black, molybdenum (Mo), and tungsten (W).

20. The method according to claim 10, wherein the solvent in the surface layer slurry is water, an organic solvent, or a mixture thereof.
